(19) United States
(12) Patent Application Publication
(10) Pub. No.: US 2023/0401358 A1
(43) Pub. Date: Dec. 14, 2023

(54) WIRELESS POWER (WP) SYSTEM-OF-SYSTEM (SOS) APPARATUS INCLUDING ANALYSIS AND VISUALIZATION

(71) Applicant: The United States of America, as represented by the Secretary of the Navy, Crane, IN (US)

(72) Inventors: Corey Bergsrud, Bloomington, IN (US); Alex Lynne Zellner, Indianapolis, IN (US); Bradley T Sutton, Bloomington, IN (US); Alexander Canady, Bloomington, IN (US)

(73) Assignee: The United States of America, as represented by the Secretary of the Navy, Arlington, VA (US)

(21) Appl. No.: 18/209,653

(22) Filed: Jun. 14, 2023

Related U.S. Application Data
(60) Provisional application No. 63/351,955, filed on Jun. 14, 2022.

(51) Int. Cl. G06F 30/20

(52) U.S. Cl. CPC G06F 30/20; H02J 50/00

(57) ABSTRACT

Systems and methods are provided for improving wireless power system design and analysis using a System-of-Systems (SoS) approach. The SoS approach includes multiple systems for analyzing, modeling, and simulating various aspects of wireless power system, particular for wireless power systems for unmanned aerial vehicles. The multiple systems include using a multiphysics approach that accounts for electromagnetic, thermal, and structural aspects of a wireless power system, such as for a rectenna design. The SoS approach further includes allowing selection and/or input of various variables such as diode selection, geographic/atmospheric, and other measured data/information to more closely model and simulate real world conditions.

### CROSS-REFERENCE TO RELATED APPLICATIONS

The present application claims the benefit of and priority to U.S. Provisional Patent Application Ser. No. 63/351,955, filed Jun. 14, 2022, and entitled “WIRELESS POWER (WP) SYSTEM-OF-SYSTEM (SOS) APPARATUS INCLUDING ANALYSIS AND VISUALIZATION,” the disclosure of which is expressly incorporated by reference herein.

### STATEMENT REGARDING FEDERALLY SPONSORED RESEARCH OR DEVELOPMENT

The invention described herein includes contributions by one or more employees of the Department of the Navy made in performance of official duties and may be manufactured, used and licensed by or for the United States Government for any governmental purpose without payment of any royalties thereon. This invention (Navy Case 210094U502) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The field of the present disclosure generally relates to modelling and simulation of wireless power systems, and more particularly to providing a system-of-systems (SoS) design and analysis apparatus or schema for modelling and simulating wireless power systems.

### BACKGROUND

For design of wireless power systems, there are a number of design and analysis schema that have been used for modelling and simulation of such wireless power systems. One previous approach includes U.S. Pat. No. 10,574,097 entitled “Dynamic Wireless Power/Energy Transfer System Apparatus Including Modeling and Simulation (M and S), Analysis, and Visualization (MSAV) Systems along with Related Methods” to assess the feasibility of a certain military scenarios, the entirety of which is incorporated herein by reference. With increased complexities such as multiphysics or harmonic balance analysis and design of circuit aspects, previous systems do not fully incorporate analysis of such increased complexities. The currently known technology only offers a very basic calculation capability and “rule of thumb” approaches. Accordingly, more advanced tool sets for wireless power system design and analysis are desirable.

### SUMMARY

The present disclosure relates to relates to modeling and simulation of wireless power systems, and more particularly to providing a system-of-systems (SoS) design and analysis apparatus, methods, and/or schema for modelling and simulating wireless power systems.

According to aspects, the present disclosure provides a system for use in designing, optimizing, and manufacturing a wireless power system. The system includes a System-of-Systems (SoS) system for design and analysis of the wireless power system, the SoS system including a plurality of design modules configured for design and analysis of respective portions of the wireless power system. The system further includes an input variable interface adapted to enable graphical user interface selection of wireless system parameters or receive wireless system parameters. Additionally, the system includes an output user interface generator configured to generate a collection of efficiency graphical analysis data, atmospheric efficiency graph data, and rectenna RF to DC conversion efficiency graph data associated with said at least one design scenario of the wireless power system, efficiency values comprising rectenna, atmospheric, and collection percentage values associated with the wireless power system being simulated, and output DC power data.

### BRIEF DESCRIPTION OF THE DRAWINGS

FIG. 1 shows an exemplary operational environment with an airborne platform having a wireless power transfer system and a power transfer platform according to aspects of the disclosure.

FIG. 2 shows another example of an exemplary operational environment with a wireless power transfer system and platform for providing power transfer to a plurality of airborne platforms according to aspects of the disclosure.

FIG. 3 shows yet another example of an exemplary operational environment with a wireless power transfer system and multiple power transfer platforms for providing power transfer to a plurality of airborne platforms according to aspects of the disclosure.

FIG. 4 shows a simplified exemplary block diagram of aspects of a system which is being modeled or simulated by the disclosed system according to aspects of the disclosure;

FIG. 5 illustrates an exemplary circuit diagram of a rectenna element of the rectenna of FIG. 4 according to aspects of the disclosure.

FIG. 6 illustrates a block diagram of an apparatus for providing an SoS approach or schema for analysis of wireless power system according to aspects of the disclosure.

FIG. 7 illustrates a flow chart of processes implemented by the presently disclosed system of systems (SoS) approach according to aspects of the disclosure.

FIG. 8 shows a flow chart of a wireless power (WP) system model capability implemented by the presently disclosed system of systems (SoS) approach according to aspects of the disclosure.

FIG. 9 illustrates another example of a flow chart of a wireless power (WP) system model capability implemented by the presently disclosed system of systems (SoS) approach according to aspects of the disclosure.

FIG. 10 illustrates an exemplary screen that may be displayed by a graphical user interface (GUI) by the disclosed inventive system for wireless power analysis according to aspects of the disclosure.

FIG. 11 shows an exemplary generated graph or plot of atmospheric efficiency for various geographic locations according to aspects of the disclosure.

FIG. 12 shows an exemplary input interface for determining or setting atmospheric efficiency for various geographic locations according to aspects of the disclosure.

FIG. 13 illustrates an exemplary screen that may be displayed by a graphical user interface (GUI) by the disclosed inventive system for diode analysis according to aspects of the disclosure.

FIG. 14 illustrates a flow diagram of a multiphysics analysis approach implemented by the present system according to aspects of the disclosure.

FIG. 15 illustrates an example of a simulated experiment of the multiphysics model implemented by the present system according to aspects of the disclosure.

FIG. 16 illustrates one example of a printed circuit board (PCB) rectenna as modeled and simulated using the multiphysics modeling as disclosed herein

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. It will be apparent to those skilled in the art, however, that these concepts may be practiced without these specific details. In some instances, well known structures and components are shown in block diagram to avoid obscuring such concepts.

The disclosed invention provides a System-of-Systems (SoS) design and analysis approach to design, optimization, and planning manufacturing of a wireless power system. The disclosed SoS design and analysis approach addresses, in part, design and analysis consideration for a wireless power receive system and high intensity fields (e.g., increasing surface power density on a receive structure) from thermal and electrical performance aspects. The present invention affords the ability to assess multiphysics (electrical-thermal-structural) aspects to better understand and characterize these performance relationships. Both multiphysics and circuit design models require advance modeling and simulation capabilities.

Of note, the present disclosure utilizes, at least in part, a framework similar to that disclosed in U.S. Pat. No. 10,574,097, but including more advanced electrical modeling capability in an SoS approach. The presently disclosed SoS engineering and operational design tool set and process affords rapid aid to designers and operational planners on wireless power components and their effects on operations/utility. Furthers, the presently disclosed invention affords design of various model aspects (e.g., a multiphysics, circuitry, etc.) as an SoS approach offering varying levels of sophistication details that are incorporated into the model. The presently disclosed invention offers broad design aspects for components and applications to be evaluated through an SoS approach. Moreover, the presently disclosed invention offers varying assessment sophistications to the developers and operational planners, which can be dependent on or account for the application requirements.

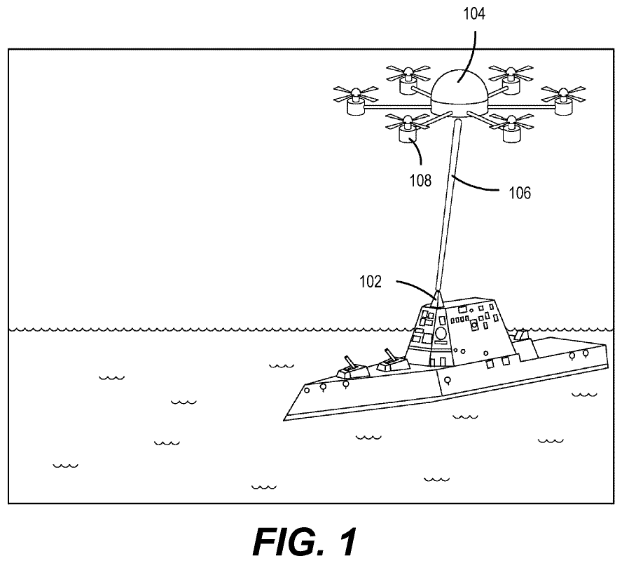

Referring to FIG. 1, this figure illustrates an exemplary operational environment of a simplified wireless power transfer system that includes one or more power transfer emitters 102 (note only one emitter 102 is illustrated but the system could include multiple power transfer emitters) for emitting wireless power (WP) to one or more devices, such as one or more airborne platforms 104 (e.g., Unmanned Aerial Vehicles (UAV), Unmanned Aerial Systems (UAS), Small UAV (sUAV), Small UAS (sUAS), or “drones”). Note that even though one platform 104 is illustrated, multiple platforms 104 are also envisioned. The platform 104 may also have one or more motor/propeller assemblies 108.

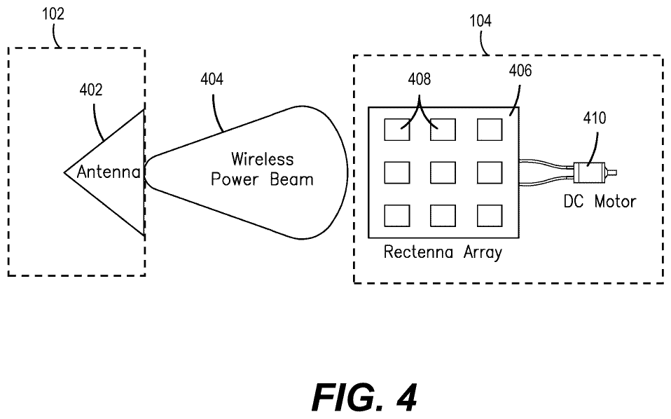

While not shown in FIG. 1, the one or more airborne platforms 104 include a power receiving antenna device such as a rectenna (e.g., rectenna 406 shown in FIG. 4 and to be discussed later) that receives the emitted WP (e.g., an electromagnetic beam at RF frequency such as a microwave beam 106) from the wireless power transfer emitter 102. The wireless power transfer emitter 102 can be located on various fixed or mobile platforms, including, for example, a ship as shown in FIG. 1. Such systems can be used to enable persistent or long duration flight or operation remote from a power supply or a fuel system such as a refueling system on board the ship or on ground.

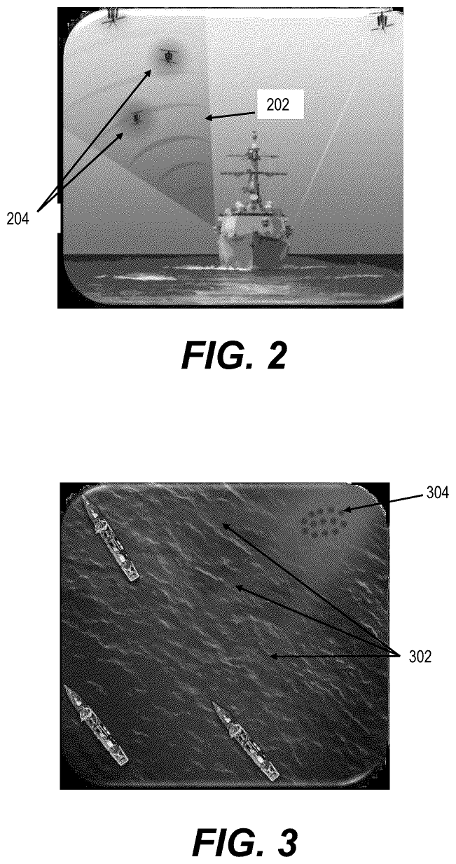

In other aspects, FIG. 2 illustrates an example of a wireless power system that may be modeled with the present invention where a wide beam 202 may be used to wirelessly transfer power to a plurality of airborne platforms 204 from a single wireless power transfer emitter. In yet another example, FIG. 3 shows an example of a wireless power system that may be modeled with the present invention where multiple beams 302 from respective power transfer emitters of a plurality of power transfer emitters that are collectively used to power a multiple number of airborne platforms 304.

FIG. 4 shows a simplified exemplary block diagram of certain aspects of an exemplary wireless power or energy system that may be modelled or simulated by an exemplary embodiment of the wireless power SoS modelling apparatus according to aspects of the present disclosure. In this example, power transfer emitter 102 includes a transmitter antenna 402 that transmits a wireless power beam 404 toward one or more or more airborne platforms 104. The one or more airborne platforms 104 each may include one or more rectenna arrays 406, which, in turn, may consist of multiple elements 408.

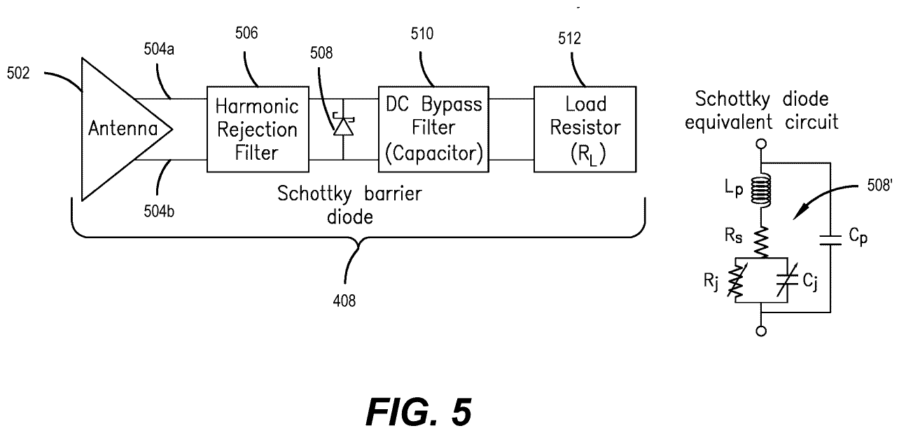

FIG. 5 illustrates an exemplary structure of array element 408 that converts the transmitted wireless power beam 404 into a DC voltage to be used by systems on the platform 104, e.g., a DC motor 410 in FIG. 4, but not limited to such. Element 408 includes a receiving antenna 502, two or other electrical couplings 504a and 504b, which may be coplanar strips in some aspects, that couple the antenna 502 to a harmonic rejection filter 506, as well as other elements of the element 408 in parallel. FIG. 5 further illustrates that the element 408 may include a Schottky barrier diode 508 (or similar device) for AC to DC rectification, and a DC bypass filter 510 (which may be embodied with a capacitor or capacitance engendered through a network of capacitors) to smooth the DC voltage. The rectified and filtered DC voltage is supplied to a load 512, which may be a resistive load as shown, a DC motor such as 410 in FIG. 4, and/or other loads such as a battery charger for charging on-board batteries, or controller(s) for controlling onboard systems. In a further example, the Schottky barrier diode 508 may be effectuated with an equivalent circuit using only passive resistive, inductive, and capacitive elements as shown at 508′, variants of which may be modeled and simulated with the presently disclosed system.

Past approaches, including those discussed in U.S. Pat. No. 10,574,097, do not utilize an SoS tool set because they are mostly focused on optimizing hardware/software for single use applications for commercial demonstrations, as an example. The presently disclosed invention, on the other hand, offers broad design aspects for components and applications to be evaluated through an SoS approach. Moreover, the presently disclosed invention offers varying assessment sophistications to the developers and operational planners, depending on the applications requirements.

In particular, the presently disclosed invention includes a package or system consisting of a set of tools with a streamlined approach that offers greater flexibility, simplicity, and speed to aid component and operational/utility wireless power designers in an SoS approach. The disclosed invention contributes to advancing the field of wireless power by giving the component and operational/utility designers the capability to investigate a vast trade space (e.g., a vast number of variables affecting system design and performance) with greater simplicity and speed through an SoS model and approach. This more holistic approach affords greater design aspects and details to developers, thus reducing errors and time in the process. Moreover, to account for varying levels of anticipated users, the model and approach is designed in a manner that offers different levels of sophistication as desired. This allows a larger customer base to access the tool set as well as offering varying level of details needed in the design that can be selected or individually determined by the developers. Furthermore, the presently disclosed tool is designed to broadly cover numerous cases and/or trade studies.

In yet other aspects, the present invention features a multiphysics model system. By building a multiphysics model system to help characterize the multiphysics (electrical-thermal-humidity-structural) aspects of a wireless power system, the present invention offers a novel assessment block that has not been previously known to be utilized. The present invention, thus, provides a clear sense of all the different design aspects or systems in WP design, and creates a way to simultaneously incorporate these design aspects into an analysis structure.

In still other aspects, the presently disclosed invention provide WP SoS design tools and processes that are configured to broadly capture numerous measured or simulated inputs into the system and the machine can rapidly assess feasibility of a WP system design and performance based on those inputs. The presently disclosed invention focuses on an SoS design and analysis that can afford rapid build of integrated product lines and rapid operational/utility assessment. In addition, the presently disclosed invention provides an integrated and automated apparatus that allows for on-the-fly design changes and assessments of WP systems. Moreover, modifications to the tool set could be applied to a WP Operational Energy Common Operating Picture (COP) layer for increased Situational Awareness (SA) and a Command and Control (C2) structure to inform recharging. In addition, the disclosed invention offers contemplated additional application pathways through wireless power operational energy COP layer for SA and C2 functions of sensor/platform for informing and delivering re-charge to operating platforms, for example.

The disclosed invention includes tools and processes designed to evaluate Wireless Power (WP) Systems-of-System (SoS) engineering and operational design scenarios. The disclosed invention has three levels of sophistication: (1) built in mathematical and physical models with rule of thumb assumptions; (2) advanced circuit and antenna modeling & simulation tools, and; (3) measured data. Key WP SoS components can be assessed for their engineered system performance, as well as their operational performance in an SoS. Key WP SoS components could include diode, rectifier, antenna, antenna array, rectifying antenna (rectenna), rectenna arrays, and energy storage devices. These components electrical performances can be assessed under room temperature/humidity (normal base line conditions) or under changes in temperature and/or humidity conditions based on changes in surface power density applied by external field and/or by natural environmental conditions. In addition, operational requirements (mission requirements, receiving platform, radiator(s), location(s), etc.) combined with key components can be assessed holistically as an SoS in the model for its feasibility and/or scope. The disclosed invention offers a streamlined approach for assessing numerous parameters and conditions within a WP engineering and operational design environment. In addition, the disclosed invention has visualizations to aid the designers in assessing the component or SoS effects of inputs and outputs to and from the model, respectively.

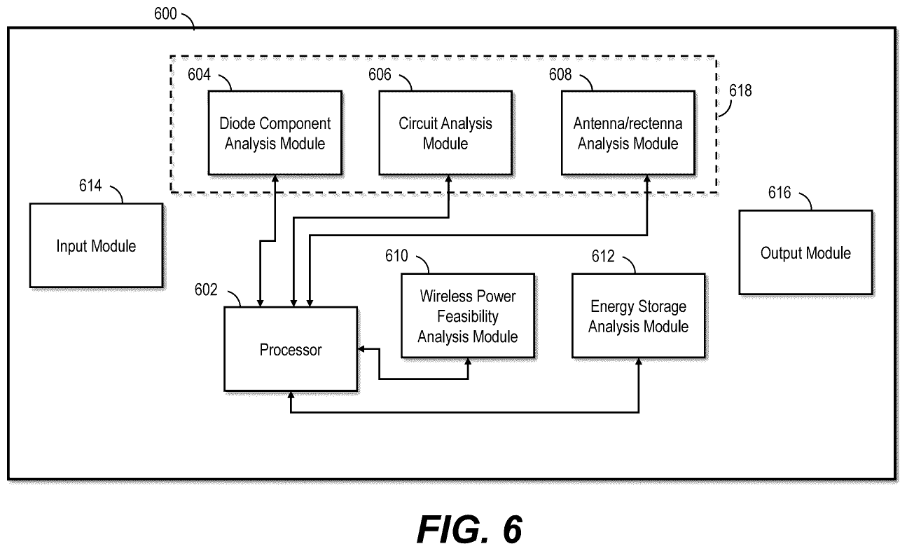

FIG. 6 illustrates a block diagram of an apparatus 600 for providing an SoS approach or schema for analysis of wireless power system, wherein the apparatus may be implemented with hardware, software, firmware, or combinations thereof. In further aspects, the apparatus 600 may be implemented as a computer system including a processor(s) 602 for implementing the various blocks/modules, or entire apparatus 600 may be embodied in one or more processors.

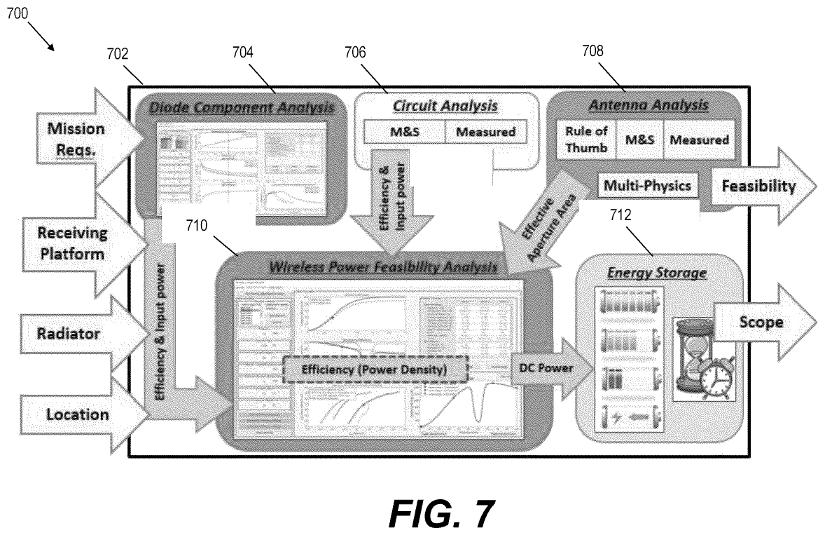

The apparatus 600 may include at least one processor 602 that is configured to interface with a number of modules including, but not limited to, a diode component analysis module 604, a circuit analysis module 606, an antenna or receive antenna (rectenna) analysis module, a wireless power feasibility analysis module 610, and an energy storage analysis module 612. Furthermore, the apparatus 600 may include an input module 614, which may be embodied to include one or more graphical user interfaces (GUIs) and/or networking devices, for receiving information including mission requirements, UAV platform information including battery information and power management information, power transmission device or transmitter antenna information, diode component information, rectenna design parameters or information, geographical location information including atmospheric data concerning the location, multiphysics feedback information (e.g., electromagnetic, thermal, and/or structural information concerning the UAV platform), and/or flight performance data. The various modules 602, 604, 606, 610, and/or 612 are configured to utilize the data and determine or calculate a wireless power feasibility analysis, as well as energy storage analysis. The results may be output via an output module 614, which may be embodied to include one or more graphical user interfaces (GUIs) and/or networking devices. It is noted that various GUIs associated with processes that may be employed in apparatus 600 may be seen illustrated in the various figures herein including FIGS. 7-14, which are discussed below.

In still further aspects, one or more of the modules 604, 606, and 608 may employ multiphysics modeling and simulation, as is indicated by box 618. The particular aspects of the multiphysics modeling and simulation will be discussed in more detail below.

FIG. 7 illustrates a flow chart 700 of processes implemented by the presently disclosed system of systems (SoS) approach according to aspects of the disclosure. In this example, the box 702 represents the system, which may be the sum or total of various analysis blocks that may be utilized to model capabilities of a wireless power system. The system 702 receives input information from a user or other algorithms (or both) such as mission requirements, information from a receiving platform, electromagnetic radiator or transmission information, and geographic location information, but inputs are not limited to such.

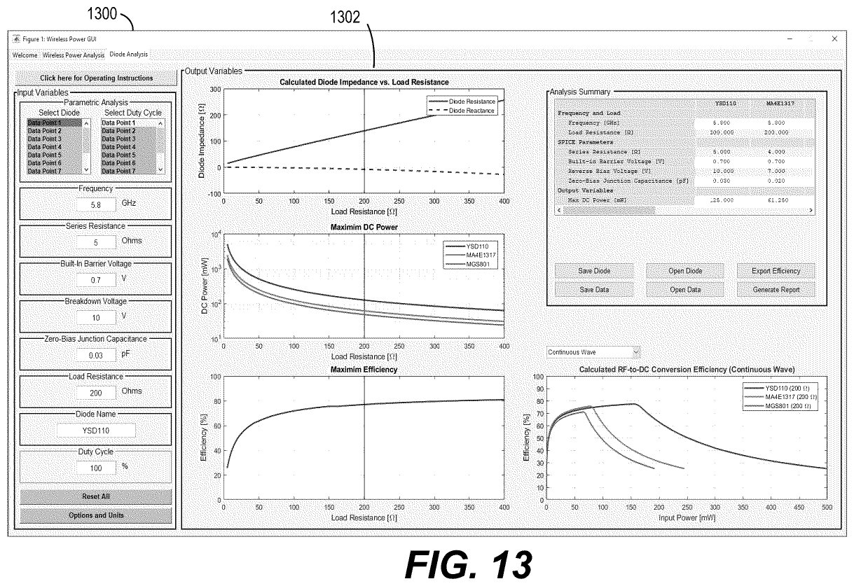

Additionally, the system 702 includes a process 704 for diode component analysis, which is configured to perform various modeling of a rectenna diode component(s) (See e.g., diode 508 or 508′), the interface of which is illustrated at 1300 in FIG. 13. Furthermore, the system 702 includes a process 706 for circuit analysis of circuitry for power delivery and reception, among other things. The circuit analysis function/module 706 affords the ability for circuit modeling and simulation (M&S) including M&S based on measured data (e.g., voltages, currents, impedances/resistances, etc.). Still further, the system 702 includes an antenna analysis process/module 708 that utilizes various functions within the module 708. These include modeling and simulation, use a measured values, application of standards or “rules of thumb” for antenna design, measure data, as well as a multiphysics approach that will be discussed in more detail later.

Yet further, the system 702 includes a wireless power feasibility analysis function or module 710 that receives the analysis information from each of functions or modules 704, 706, and 708 including efficiency and input power information, as well as effective aperture area (e.g., optimization of antenna configuration and area) from the antenna analysis module 708. The analysis module 710 affords determination of the efficiency (e.g., power density) for the wireless power that may be transferred to a UAS, for example, and also provides power information (e.g., DC power) for energy storage management by an energy storage process or module 712. The outputs of the system 702 may include, but are not limited to, a feasibility analysis/determination and scope information (e.g., what ability or scope is available for a UAS based on the wireless power efficiency available).

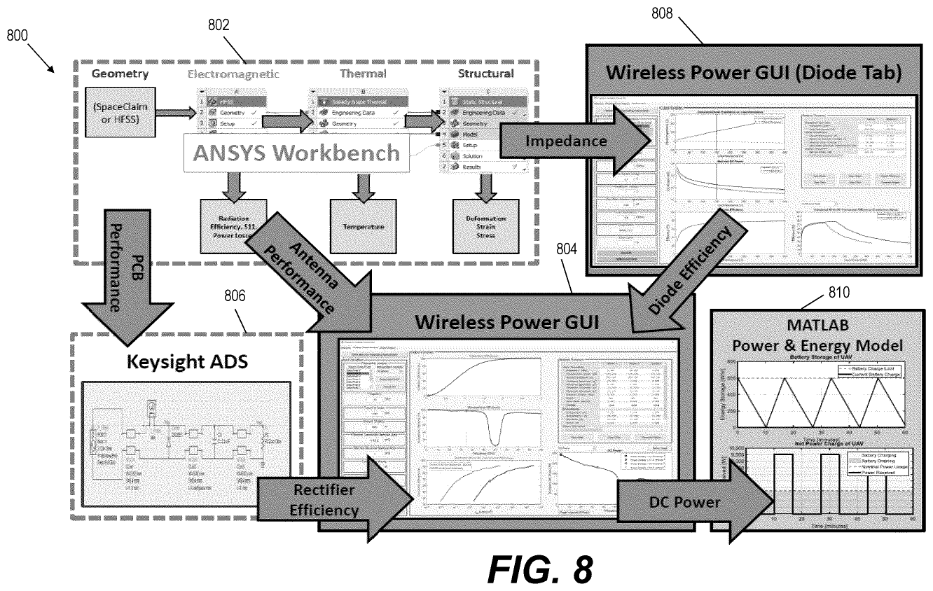

FIG. 8 shows a flow chart of a process 800 that determines wireless power (WP) system model capability implemented by the presently disclosed system of systems (SoS) approach according to aspects of the disclosure. Additionally, it is noted that FIG. 8, in part, illustrates one or more exemplary screens that may be displayed by a graphical user interface (GUI) by the disclosed inventive system for wireless power analysis according to aspects of the disclosure.

As shown in FIG. 8, processes in overall process 800 may include the use of an advanced tool set 802 such as a multiphysics simulation for product design, testing and operations for the wireless power scenario. In the illustrated example, an ANSYS workbench is illustrated for analyzing the wireless power scenario, but is not limited to such and other products/software tools with equivalent functionalities may also be utilized. The process 802 includes analysis of antenna geometry, as well as electromagnetic, thermal, and structural properties for antenna design to better achieve desired antenna, and analysis of printed circuit board (PCB) features to better optimize PCB performances (e.g., performance of rectifier circuitry/circuit boards such as was illustrated in FIG. 5). Concerning electromagnetic, thermal, and structural properties for antenna design, the process 802 includes analysis providing radiation efficiency/power losses and antenna parameters (e.g., reflection coefficient S11) based on electromagnetics analysis, temperature parameters based on thermal analysis, and deformation/stain/stress parameters based on the structural analysis. Still further, in the example of use of ANSYS, the geometry analysis utilizes high-frequency structure simulator/simulation software (HFSS) or SpaceClaim solid modeling CAD software. The processes in 802 generate antenna performance and PCB performance parameters that are supplied to both a wireless power analysis process 804 (shown represented with merely one exemplary GUI display of many that is generated by process 804), and a design system process 806, which may be implemented by Keysight Advanced Design System (ADS) in one example as illustrated in FIG. 8, but not limited to such. The process 806 provides circuit parameters such as rectifier efficiency to the wireless power analysis process 804 as illustrated.

Additionally, the process 800 includes diode analysis process 808, and is shown illustrated by merely one exemplary GUI display of many that may be generated by process 808. The diode analysis process 808 provides diode efficiency parameters to the wireless power analysis process 804. Further, process 800 includes a power and energy modeling process 810, which is used to model power and energy of batteries or power storage in a UAS, for example, and may include battery storage energy modeling and net power charge of the UAS battery. This modeling by process 808 may be based on DC power requirements/parameters as determined by the wireless power analysis process 804.

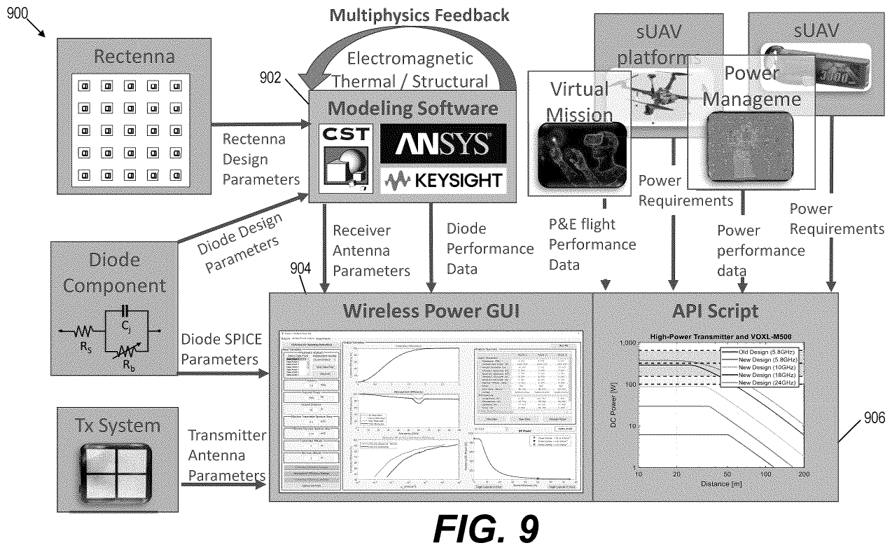

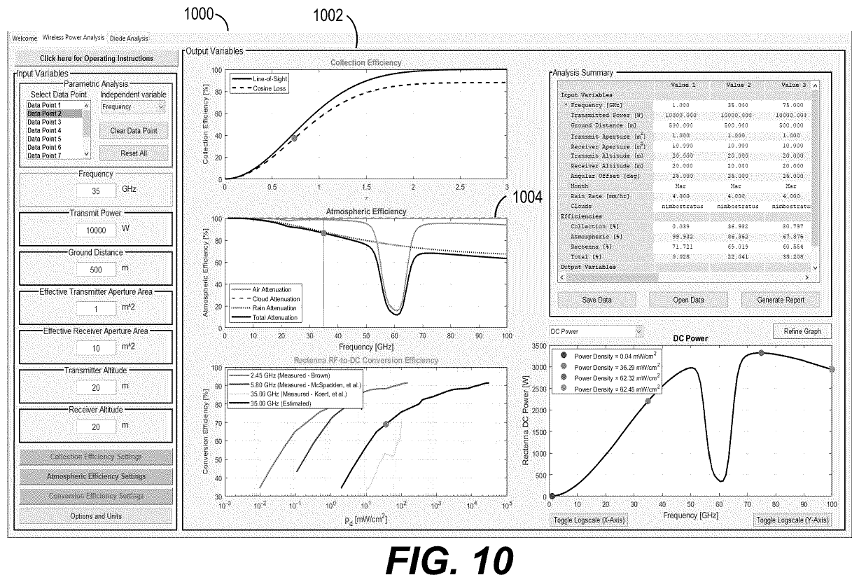

FIG. 9 illustrates another example of a flow chart or process diagram 900 of a wireless power (WP) system model capability analysis implemented by the presently disclosed system of systems (SoS) approach according to aspects of the disclosure. As shown, a modeling software as ANSYS, Keysight, and CST electromagnetic modeling software shown at module 902 provides a multiphysics approach for receiver antenna and circuit design for a wireless power system. The module 902 determines and provides receiver antenna (rectenna) parameters and circuit parameters such as diode performance and PCB parameters to the wireless power analysis process (shown here as wireless power GUI 904 and akin to the processes or modules 610, 710, or 804). Inputs to the multiphysics module 902 may include rectenna design parameters and diode design parameters. Further, the apparatus underlying the operations of process 900 may include an interface such as an application programming interface (API) 906 that receives input data about the UAS or other platform such as flight performance data, power requirements, power performance data of a UAS power management system, and power requirements of the UAV batteries in order to interface with the wireless power analysis process or module 904 and determine factors such as the high power transmitter parameters. Additionally, the wireless power analysis process/module 904 may receive diode SPICE parameters and transmitter antenna parameters for use in analysis and design of the wireless power system.

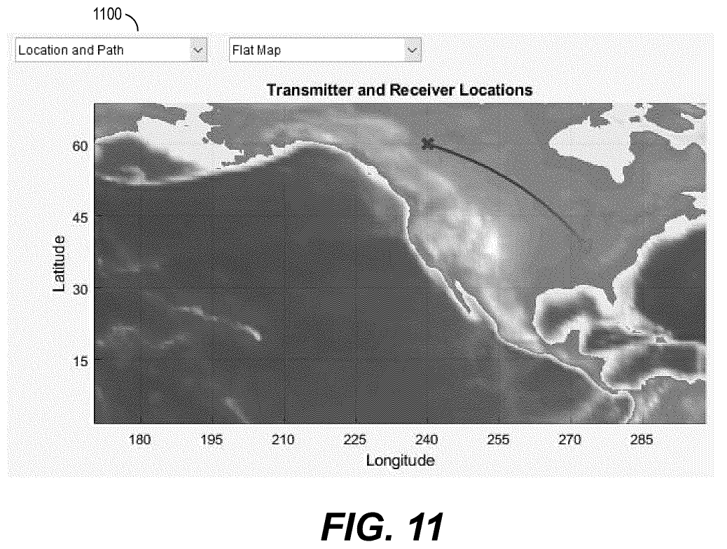

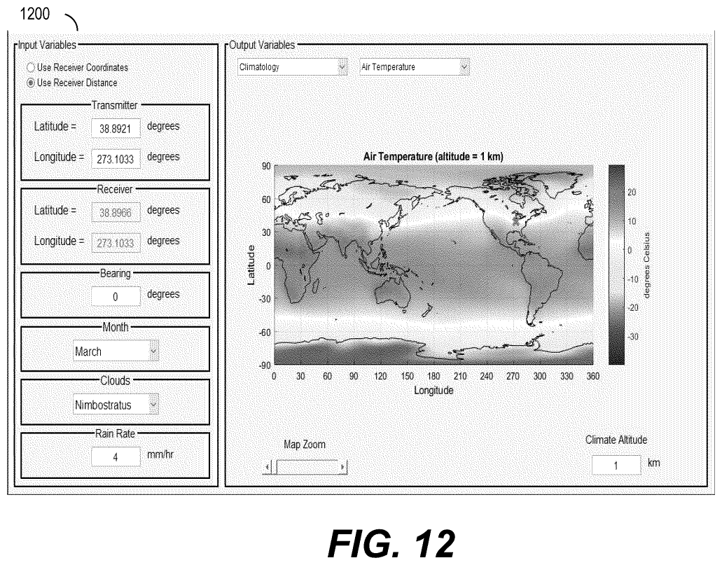

FIG. 10 illustrates an exemplary screen 1000 that may be displayed by a graphical user interface (GUI) by the disclosed inventive system for wireless power analysis according to aspects of the disclosure. This screen 1000 illustrates, for example, a GUI used by the wireless power analysis process (processes or modules 610, 710, 804, or 904). As may be seen, the input variables on the left side of the screen allow for input of a number of various design parameters. The output then includes a number of variables/parameters as may be seen in box 1002 that allow for optimization of the wireless power system design. Of note, box 1002 illustrates that geographic and atmospheric data may be analyzed and displayed to account for and optimize for conditions that the UAV may operate within. FIGS. 11 and 12 illustrate various input/output interfaces (e.g., GUIs within the wireless power analysis processes or modules) that are used for determining such parameters. In particular, FIG. 11 shows an exemplary generated graph or plot 1100 of atmospheric efficiency for various geographic locations according to aspects of the disclosure, including the ability to select geographic locations of transmitters and/or receivers. Furthermore, FIG. 12 shows an exemplary input interface 1200 for determining or setting atmospheric efficiency for various geographic locations according to aspects of the disclosure, based on various input variables. The data garnered through the interfaces of FIGS. 11 and 12 are then utilized for the determinations made by wireless power analysis process (processes or modules 610, 710, 804, or 904).

FIG. 13 illustrates an exemplary screen 1300 that may be displayed by a graphical user interface (GUI) by the disclosed inventive system for diode analysis according to aspects of the disclosure. As may be seen in this figure, various input variables concerning the WP system may be selected, as well as parameters for the particular diode in the rectenna system. Based on these inputs, various output variables and analysis data are determined and displayed as shown at box 1302. In one example, data from various diodes may be displayed and compared in order to determine optimal choice of diode design/selection for the particular UAS application and mission.

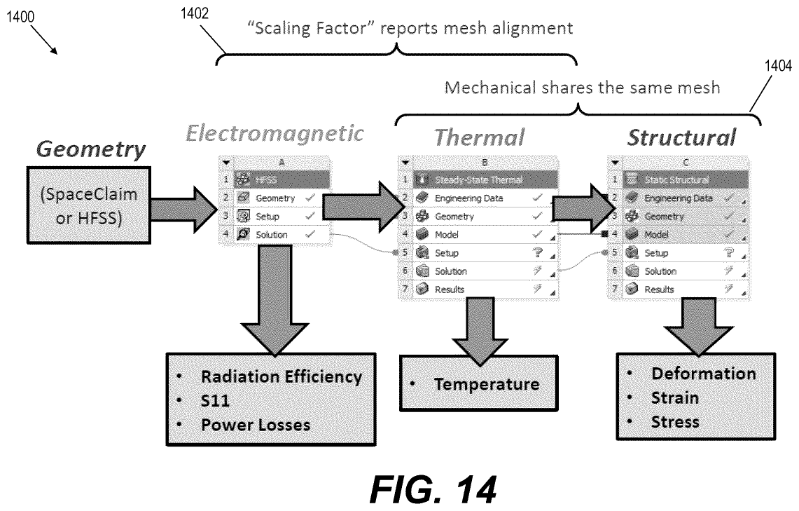

FIG. 14 illustrates a flow diagram 1400 of a multiphysics analysis approach implemented by the present system according to aspects of the disclosure. In some aspects, the flow diagram 1400 corresponds with module 802 illustrated in FIG. 8. This diagram 1400 illustrates an exemplary flow of the multiphysics model utilized by the presently disclosed system. In this example, the electrical performance of a particular geometry (e.g., printed circuit board rectenna) may be evaluated based on varying input power, thermal changes, and structural changes. In further aspects, it is noted that the combination of electromagnetic and thermal parameters yields a scaling factor that reports mesh alignment as shown at bracket 1402. The combination of thermal and structural parameters yields a mechanical factor that shares a same mesh alignment as shown at bracket 1404.

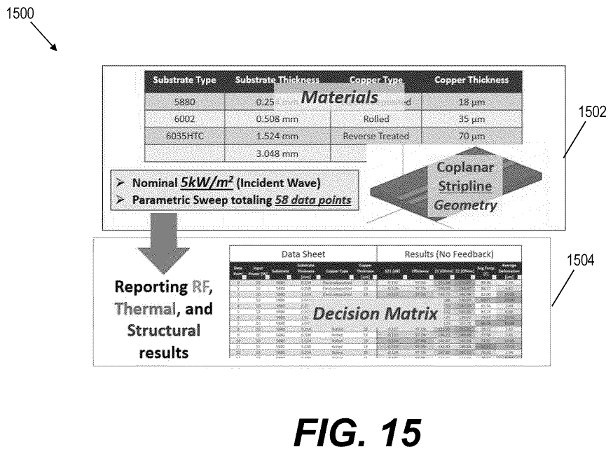

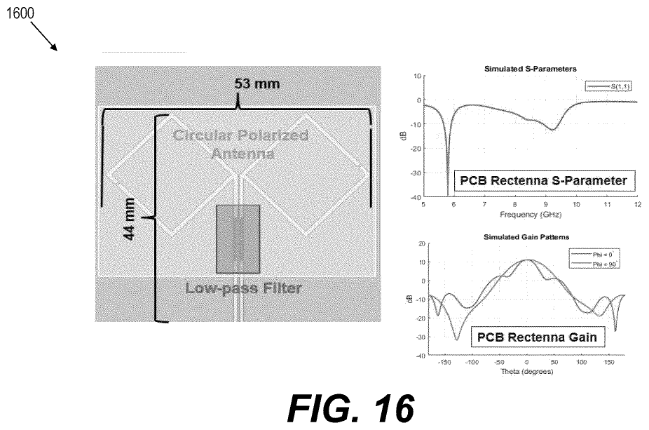

FIG. 15 illustrates an example of a simulated experiment of the multiphysics model. In this example, a coplanar stripline (CPS) geometry was used along with a number of different material property types. Based on the combination of materials run through the multiphysics model shown at block 1502, a decision matrix 1504 is generated to provide a user of the system design and material combinations that perform the best. The matrix 1504 accounts for electromagnetic (e.g., RF), thermal, and structural considerations.

FIG. 16 illustrates one example 1600 of a printed circuit board (PCB) rectenna as modeled and simulated using the multiphysics modeling as disclosed herein. In this particular example rectifier circuitry is not illustrated. Further, this particular example illustrates the used of ANSYS HFSS advance software, but those skilled in the art will appreciate that other modeling software may be utilized for multiphysics modeling. Additionally, the modeling provides graphing of power gain verses S-parameters, and power gain over various angles of RF reception.

The disclosed invention allows a System-of-Systems (SoS) design and analysis approach to a wireless power scenario. Most subject matter experts (SMEs) realize the complexities of the trade space. Broad knowledge and expertise as well as creativity are needed to commence in the vast trade space required for an optimal wireless power solution set and vision for the future that informs present day design. The presently disclosed invention affords broad capture of numerous measured or simulated inputs into the system and the apparatus can further rapidly assess a wireless power system scenario and performance based on those inputs. The disclosed SoS design and analysis may be utilized to inform rapid build of integrated product lines, and rapid operational/utility assessment. In addition, the presently disclosed invention offers contemplated additional application pathways through wireless power operational energy COP layer for SA and C2 functions of sensor/platform for informing and delivering recharge.

In still further aspects, the presently disclosed invention can be configured as a package consisting of a set of tools with a streamlined approach that offers greater flexibility, simplicity, and speed to aid component and operational/utility wireless power designers in an SoS approach. The presently disclosed invention contributes to advancing the field of wireless power by giving the component and operational/utility designers them capability to investigate a vast trade space with greater simplicity and speed through an SoS model and approach. This more holistic approach affords greater design aspects and details to the developers thus reducing errors and time in the process.

Moreover, to account for varying level of anticipated users, the presently disclosed model and approach is designed in a manner that offers different levels of sophistication. This allows a larger customer base to access the tool set as well as offering varying level of details needed in the design that is determined by the developers. Still further, the present invention provides users with a multiphysics model system accounting for number aspects (e.g., electrical-thermal-humidity-structural), which offers a novel assessment block. The presently disclosed system also makes clearer sense of all the different design aspects or systems, and creates a way to simultaneously incorporate them into an analysis structure.

In other aspects, the presently disclosed invention is a WP SoS design tool and process that broadly captures numerous key components and/or applications simultaneously to assess its feasibility and/or scope. The presently disclosed invention offers flexibility, speed, and dependability to assess broad design components and utility application through an SoS approach.

Moreover, a beneficial usage for the presently disclosed invention is to build models and integrate the flow of those models to better assess wireless power operations/scenarios based on inputting real systems-of-systems (SoS) data/characteristic components into the model. This approach increases the operational assessment accuracy closer to anticipated real-world performance. Alternative uses transform the usage from a complete theoretical assessment tool set to an operational tool set with real distributed sensors and platforms plugged into the wireless power operational energy software system layer for a common operating picture (COP) station (for both military commanders as well as commercial applications). The COP can help plan out distributed sensors and platforms from a wireless power prospective and allows operating command and control functions for recharging via the wireless power link. In addition, industry can use the tool to help rapidly assess and create new product lines that have a wireless power component as part of the design. Analyzing numerous parts simultaneously in an SoS approach allows designers to optimize the vast trade space with greater simplicity and speed.

In some aspects, the presently disclosed invention may be implemented using an application programming interface (API), which will allow the user to write (or use) their own short segments of code to transfer the data as needed to any number of software packages. This will help users to automate some of the more tedious aspects of this entire process and cut down on time required to use the tool. In addition, the presently disclosed invention may include implementation of a streamlined flow process where multiple inputs (from measured or simulated data) flow through the tool fluently to perform required calculations and provide users a clear visual of the flow and results.

Additionally, it is noted that presently disclosed invention greatly advances the art including advancing the approach of U.S. Pat. No. 10,574,097 by incorporating additional levels of sophistication to included advanced circuit and antenna modeling and simulation tools, and measured data. Moreover, the disclosed invention enhances analysis of Wireless Power technologies and applications through an SoS engineering and operational design scenario approach.

Although the invention has been described in detail with reference to certain preferred embodiments, variations and modifications exist within the spirit and scope of the invention as described herein and as defined in the following claims.

1. A system for use in designing, optimizing, and manufacturing a wireless power system, the system comprising:
a System-of-Systems (SoS) system for design and analysis of the wireless power system, the SoS system including a plurality of design modules configured for design and analysis of respective portions of the wireless power system;
an input variable interface adapted to enable graphical user interface selection of wireless system parameters or receive wireless system parameters;
an output user interface generator configured to generate a collection of efficiency graphical analysis data, atmospheric efficiency graph data, and rectenna RF to DC conversion efficiency graph data associated with said at least one design scenario of the wireless power system, efficiency values comprising rectenna, atmospheric, and collection percentage values associated with the wireless power system being simulated, and output DC power data.

2. The system of claim 1, wherein the plurality of design modules includes a multiphysics modeling module configured to characterize one or more of electrical/electromagnetic, thermal, humidity, and structural aspects of at least a rectenna used in the wireless power system.

3. The system of claim 2, wherein the plurality of design modules includes a diode component analysis module configured to model and simulate a diode element in the rectenna used in the wireless power system.

4. The system of claim 2, wherein the plurality of design modules includes a circuit analysis module configured to model and simulate circuitry and associated printed circuit board configurations used in the wireless power system.

5. The system of claim 2, wherein the plurality of design modules includes a wireless power feasibility module configured to determine and display parameters for design of aspects of the wireless power system based on inputs received from the plurality of design modules.

6. The system of claim 1, wherein the wireless power system is a system for providing wireless power to unmanned aerial vehicle (UAV).
